(19) United States
(12) Patent Application Publication
(10) Pub. No.: US 2011/0052967 A1
(43) Pub. Date: Mar. 3, 2011

(54) CABLELESS BATTERY CONNECTION SYSTEM

(75) Inventors: Mark Barnes, Fort Wayne, IN (US); Jonathan D. Batdorff, Fort Wayne, IN (US)

(73) Assignee: International Truck Intellectual Property Company, LLC., Warrenville, IL (US)

(21) Appl. No.: 12/508,960

(22) Filed: Aug. 27, 2009

(51) Int. Cl. H01M 6/42; H01M 2/30

(52) U.S. Cl. 429/158; 429/178

(57) ABSTRACT

A battery includes a first pair of terminal connectors including a positive and a negative terminal connector and a second pair of terminal connectors including a positive and a negative terminal connector. The positive and negative terminal connectors of the first pair of terminal connectors are sized and shaped for mating with the positive and negative terminal connectors of the second pair of terminal connectors, allowing the battery to coupled by like polarity terminals to a second like battery.

### BACKGROUND

1. Technical Field

The disclosure relates to motor vehicle battery systems and more particularly to interconnecting individual batteries in multiple battery systems.

2. Background Description

Battery based starter systems for heavy duty trucks often rely on the connection of three or four batteries in parallel to supply the current drawn by a twelve volt direct current starter motor. The starter motor draws so much current due to the substantial displacement and high compression of the vehicles' diesel engines. Twenty-four volt systems usually employ two twelve volt automotive type batteries connected in series. Whichever system is used, connection of the batteries to one another has typically been done by using jumper cables connected between battery terminals. For a truck having a twelve volt starting system and using four parallel connected batteries, this has meant using six jumper cables, three for connecting the positive terminals to one another and three for connecting the negative terminals to one another. Given that there are typically two battery cables for connecting the positive and negative terminals of one battery to the vehicle's starter system and possibly another battery cable for connecting one negative terminal of a battery to the frame of the vehicle to ground it, the presence of so many cables has the latent possibility of promoting a mistake in connection of one or more batteries.

### SUMMARY

A battery for a motor vehicle electrical system application includes a first pair of terminal connectors including a positive and a negative terminal connector and a second pair of terminal connectors including a positive and a negative terminal connector. The positive and negative terminal connectors of the first pair of terminal connectors are sized and shaped for mating with the positive and negative terminal connectors of the second pair of terminal connectors, allowing the battery to coupled by like polarity terminals to a second like battery. This allows arrays of batteries to be built in parallel electrical connection and in physically close proximity without the use of jumper cables.

### BRIEF DESCRIPTION OF THE DRAWINGS

FIG. 1 is a perspective view of a truck.

FIGS. 2A and B are front and back views of a battery having front and rear side terminals.

FIG. 3 is a cross sectional view of a battery having front and rear side terminals.

FIG. 4 is a possible configuration of an array of batteries constructed from the battery type of FIGS. 2A-B and FIG. 3 and connected in parallel for use in a truck electrical system.

### DETAILED DESCRIPTION

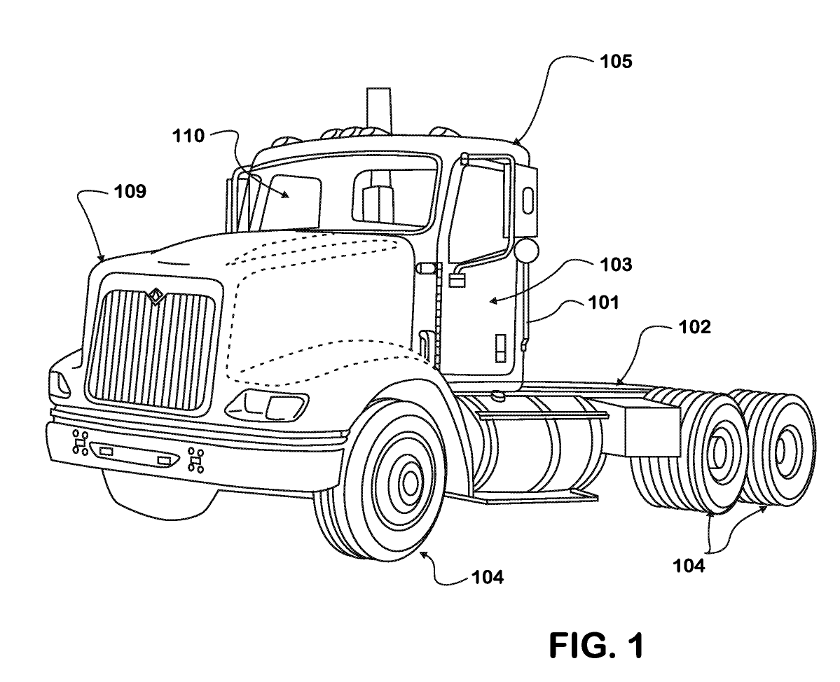

Referring to FIG. 1, a truck 101 is shown. Truck 101 has a vehicle electrical system which includes an array of batteries. The array of batteries may be located in a battery box 102 is installed on a frame rail 103 of the vehicle 101, just forward from rear wheels 104. The array of batteries in battery box 102 is electrically connected to a vehicle electrical system which includes an engine starter system.

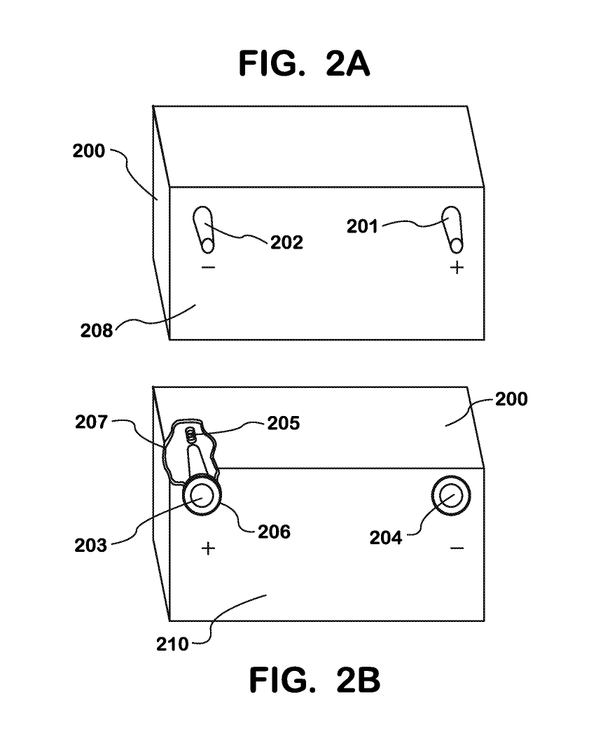

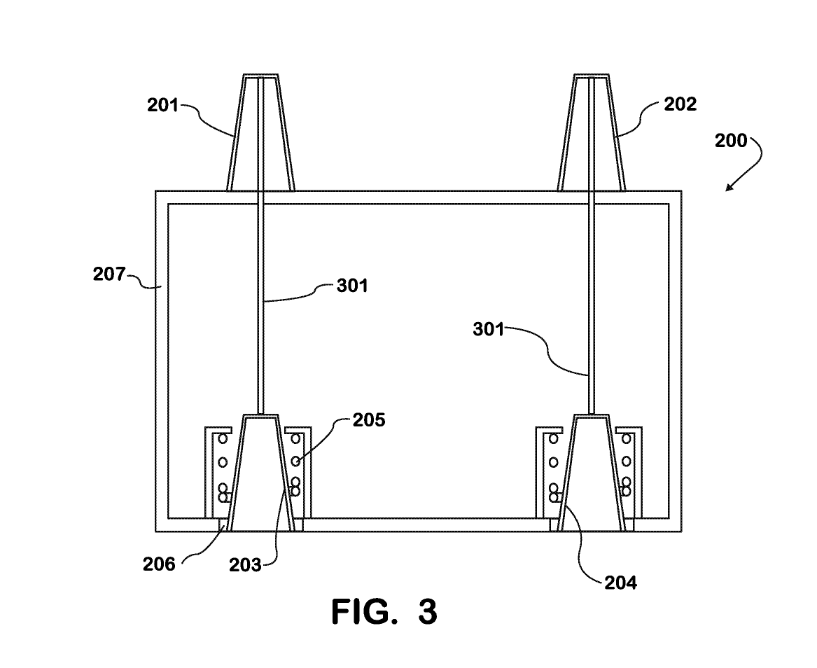

FIGS. 2A-B and FIG. 3 illustrate a battery 200. Lead acid automotive batteries have usually been constructed with a pair of external terminal connectors. The pair of terminal connectors have been located on the top of the battery or along one side. Battery 200 has pairs of positive and negative side terminal connectors (including front side terminal connectors 201, 202 and rear side terminal connectors 203, 204) on each of two opposed sides, here arbitrarily defined as a front side 208 and a rear side 210. The front side 208 has post type terminals including a positive male terminal connector 201 and a negative male terminal connector 202, which are outwardly projecting frusto-conical elements. The rear side 210 is equipped with recessed terminals including a positive female terminal connector 203 and a negative female terminal connector 204, which are shaped, spaced and located on the rear side to be mated with the positive male and negative male terminal connectors 201, 202 of a second battery 200 when two batteries are positioned side by side with rear and front sides proximate to each other. Put another way, the positive terminal connectors 201 and 203 are located aligned on one another from back to front of the battery 200. The negative terminal connectors 202 and 204 are similarly aligned. The positive terminal connectors 201, 203 of a battery 200 are internally connected by conductors 301, 302 to one another, as are the negative terminal connectors 202, 204. The female terminal connectors 203, 204 may be spring 205 loaded to urge the surface of the female terminal connectors into solid electrical contact with the surfaces of the male terminal connectors 201, 202. The female terminal connectors 203, 204 are joined to the case 207 forming an outer wall for battery 200 by pliable circular seals 206 set around the open end of the terminal connectors adjacent the wall.

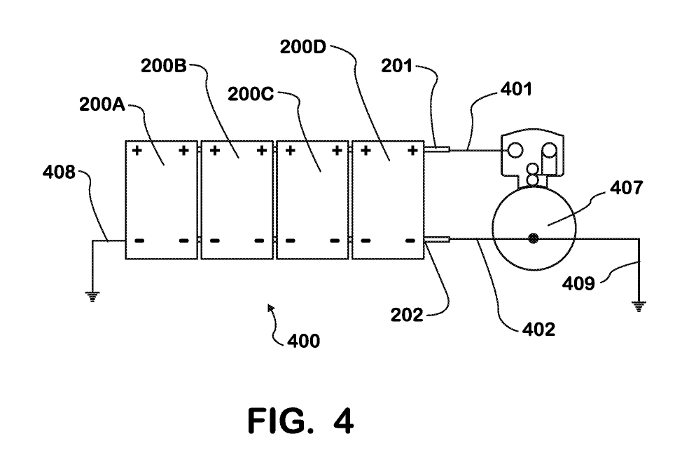

Referring to FIG. 4, a system or array 400 of batteries 200A, 200B, 200C and 200D is illustrated with the batteries places front to back to connect the batteries in parallel to supply a vehicle electrical system including a starter system 407. The positive male and negative male terminal connectors 201, 202 of the final battery 200D in the array 400 are connected by battery cables 401, 402, respectively to the starter system 407. The negative female terminal connector 204 of the first battery 200A in the array 400 is connected electrically to the vehicle chassis or other local ground by a conductor or battery cable 408. Starter system has a ground conductor 409 connected to an engine ground. Array 400 is held together by a clamping system 410. The number of batteries in the array 400 is limited only by the size of the battery box and clamping system it is used with.

Table of Reference Numerals

| | |
|---|---|
| 101 | Truck |
| 102 | Battery Box |
| 103 | Frame Rail |
| 104 | Rear Wheels |
| 200 | Battery |
| 201 | Positive F.S. Terminal Connector |
| 202 | Negative F.S. Terminal Connector |
| 203 | Positive R.S. Terminal Connector |
| 204 | Negative R.S. Terminal Connector |
| 205 | Spring |
| 206 | Seal |
| 207 | Case |
| 208 | Front Side (of Battery) |
| 210 | Rear Side |
| 301 | Conductor |
| 302 | Conductor |
| 400 | Array (of Batteries) |
| 401, 402 | Battery Cables |
| 407 | Starter System |
| 408 | Ground Conductor |
| 409 | Ground Conductor |
| 410 | Clamping System |

What is claimed is:

1. A battery comprising:
a first pair of terminal connectors including positive and negative terminal connectors;
a second pair of terminal connectors including positive and negative terminal connectors; and
the positive and negative terminal connectors of the first pair of terminal connectors being sized and shaped for mating with the positive and negative terminal connectors of the second pair of terminal connectors, allowing the battery to be coupled by like polarity terminals to a second like battery.

2. A battery as claimed in claim 1, further comprising:
front and rear sides; and
the first and second pairs of terminal connectors being located on the front and rear sides, respectively.

3. A battery as claimed in claim 2, further comprising:
the first pair of terminal connectors being posts and the second pair of terminal connectors being recessed.

4. A vehicle electrical system, comprising:
a starter system;
a plurality of parallel connected batteries for connection to the starter system; and
each parallel connected battery having a first pair of terminal connectors including positive and negative terminal connectors, a second pair of terminal connectors including positive and negative terminal connectors, and the positive and negative terminal connectors of the first pair of terminal connectors being sized and shaped for mating with the positive and negative terminal connectors of the second pair of terminal connectors.

5. A vehicle electrical system as set forth in claim 4, further comprising:
the plurality of parallel connected batteries being ordered with successive batteries each being connected to two other batteries by like polarity terminal connectors, excepting a first battery and a last battery, with the first battery being connected to ground and the last battery being connectable to the starter system.

6. A vehicle electrical system as set forth in claim 5, further comprising:
the plurality of parallel connected batteries being housed in a battery box.

7. A battery system comprising:
a plurality of parallel connected batteries;
each battery of the plurality of parallel connected batteries having a first pair of terminal connectors including positive and negative terminal connectors on a first side of the battery, a second pair of terminal connectors including positive and negative terminal connectors on a side of the battery opposite the first side;
the positive and negative terminal connectors of the first pair of terminal connectors being sized, shaped and located for mating with the positive and negative terminal connectors of the second pair of terminal connectors of a second, like battery of the plurality of parallel connected batteries.

8. A battery system as set forth in claim 7, wherein each of the plurality of parallel connected batteries further comprise:
front and rear sides; and
the first and second pairs of terminal connectors being located on the front and rear sides, respectively.

9. A battery as claimed in claim 8, further comprising:
the first pair of terminal connectors being posts and the second pair of terminal connectors being recessed to receive the posts.
